(19) United States
(12) Patent Application Publication
(10) Pub. No.: US 2011/0254946 A1
(43) Pub. Date: Oct. 20, 2011

(54) Surface inspection device

(75) Inventors: Kazuhiko FUKAZAWA, Kamakura-shi (JP); Kazuharu Minato, Yokohama-shi (JP); Haruhiko Fujisawa, Tokyo (JP)

(73) Assignee: Nikon Corporation, Tokyo (JP)

(21) Appl. No.: 13/067,033

(22) Filed: May 3, 2011

Related U.S. Application Data
(63) Continuation of application No. PCT/JP2009/005833, filed on Nov. 2, 2009.

(30) Foreign Application Priority Data
Nov. 4, 2008 (JP) 2008-283252
Jan. 26, 2009 (JP) 2009-013940

(51) Int. Cl. H04N 7/18

(52) U.S. Cl. 348/128; 348/E07.085

(57) ABSTRACT

A surface inspection device (1) includes: a stage (10) for supporting a wafer (W); an illumination system (20) for illuminating with ultraviolet light a surface of the wafer (W) supported by the stage (10); a light reception system (30) for forming an image on a predetermined imaging surface with the light from the surface of the wafer (W); a camera unit (34) for capturing an image of the wafer (W) formed on the imaging surface by the light reception system (30); a pixel compensation drive unit (35) for performing pixel compensation; a control unit (40) for controlling the operation of the pixel compensation drive unit (35) and the camera unit (34) so that the camera unit (34) captures images of a plurality of wafers (W) while performing pixel compensation using the pixel compensation drive unit (35); and an image processing unit (45) for generating a synthesized image of the wafer (W) by successively arranging the pixels in the plurality of images captured by the camera unit (34) in the order based on the pixel compensation.

This is a continuation of PCT International Application No. PCT/JP2009/005833, filed on Nov. 2, 2009, which is hereby incorporated by reference. This application also claims the benefit of Japanese Patent Application No. 2008-283252, filed in Japan on Nov. 4, 2008, and Japanese Patent Application No. 2009-013940, filed in Japan on Jan. 26, 2009, which are hereby incorporated by reference.

### TECHNICAL FIELD

The present invention relates to a surface inspection device for inspecting a surface of a substrate such as a semiconductor wafer during the semiconductor manufacturing process.

### TECHNICAL BACKGROUND

The surface inspection device mentioned above is a well-known surface inspection device in which the surface of a silicon wafer is illuminated with light, diffraction light from a repetitive pattern formed on the surface of the silicon wafer is imaged, and a pass-fail determination is made based on the change in brightness in the imaging surface (e.g., see Patent Document 1). As the pitch of the repetitive pattern in these surface inspection device has become miniaturized, the wavelength of the illumination light has been shortened to the ultraviolet range. As a result, the imaging element installed in the camera used to image the diffracted light has a smaller aperture ratio and a lower light reception efficiency.

The aperture in the light-receiving portion of the imaging element is preferably as large as possible to improve the light reception efficiency. However, because peripheral circuits for realizing certain functions such as noise reduction and information transmission have to be installed, dead zones that do not contribute to light reception have to be disposed among the pixels of the imaging element. In other words, as shown in FIG. 17, a portion combining an effective area (aperture) A for receiving light and a dead zone B occupies a single pixel in the imaging element C. As shown in FIG. 18A, the information on the image captured in effective area A (an image of wafer W) can be obtained as image information (brightness data). However, as shown in FIG. 18B, the information on the image captured in dead zone B cannot be obtained as image information (brightness data). As a result, the information from the dead zone is not included in the reproduced image.

In order to direct more light to the aperture (effective area) of the imaging element, a collector unit such as a micro lens or inner lens is installed on the imaging surface of many imaging elements. This improves the aperture ratio and reduces the dead zone. However, when an imaging element is used to capture light with a shorter wavelength, the light with a shorter wavelength such as ultraviolet light is absorbed by the micro lenses or inner lenses mentioned above (because the micro lenses and inner lenses are made of a material with superior moldability and transparency in the visible range such as PMMA). In other words, they cannot be used.

As a result, imaging elements for shorter wavelengths have a smaller aperture ratio.

### PRIOR ART LIST

### Patent Documents

Patent Document 1: Japanese Laid-open Patent Publication No. 2008-151663

### SUMMARY OF THE INVENTION

### Problems to be Solved by the Invention

In a surface inspection device necessitating the use of an imaging element with a small aperture ratio for shorter wavelength light, the aperture ratio of the imaging element is smaller. As a result, the dead zones are larger, the areas with missing information on the image captured on the imaging surface are larger, image reproducibility is poorer, and inspection precision is lower.

In order to achieve this object, the present invention is a surface inspection device for inspecting the surface of a substrate, the surface inspection device comprising: a stage for supporting a substrate; an illumination unit for illuminating with ultraviolet light a surface of the substrate supported by the stage; a light reception system for receiving light from the surface of the substrate illuminated with ultraviolet light and forming an image of the surface of the substrate; an imaging element provided with a plurality of pixels, and having an imaging surface in a position for capturing an image imaged by the light reception system, there being provided to the imaging surface a light-receiving portion for receiving and detecting light from the image, and a dead portion for not detecting light, the dead portion established around the light-receiving portion; and a setting unit for setting a relative position of the imaging element with respect to the image formed on the imaging surface, the setting unit setting the relative position so that the imaging element captures a plurality of images in a plurality of relative positions offset by an amount of relative movement that is smaller than a spacing between the pixels, and the surface inspection device comprising an image processing unit for generating a synthesized image by arranging and synthesizing, according to the relative positions, the pixels in the plurality of images captured by the imaging element.

### BRIEF DESCRIPTION OF TI DRAWINGS

FIG. 1 is a view showing the surface inspection device in the first embodiment;

FIG. 2 is a flowchart showing the process for forming an image of a surface of a wafer while performing pixel compensation;

FIG. 3A is a schematic view showing an example of the order for pixel compensation performed with a ½ pixel shift, and FIG. 3B is a schematic view showing an example of the order for pixel compensation performed with a ⅓ pixel shift;

FIG. 4 is a schematic view showing image synthesis with pixel compensation and a ½ pixel shift;

FIG. 5A and FIG. 5B are views comparing an image with pixel compensation to an image without pixel compensation;

FIG. 6 is a view showing an example of reference areas for a wafer image;

FIG. 7 is a view comparing an image with pixel compensation amount slippage and an image in which the pixel compensation amount has been corrected;

FIG. 8 is a view showing the surface inspection device in the second embodiment;

FIG. 9 is a view showing the surface inspection device in the third embodiment;

FIG. 10 is a view of the DUV imaging device in the third embodiment;

FIG. 11A and FIG. 11B are schematic views showing an imaging member in greater detail;

FIG. 12A, FIG. 12B, and FIG. 12C are schematic views showing an example of microscopic defect images captured on the imaging member;

FIGS. 13A-D and FIGS. 13A′-D′ are schematic views showing the positional relationships between a microscopic defect image and four imaging members;

FIG. 14A and FIG. 14B are views showing image processing performed by the image processing unit;

FIG. 15A and FIG. 15B are views of the DUV imaging device in the fourth embodiment;

FIG. 16A and FIG. 16B are views of the DUV imaging device in the fifth embodiment;

FIG. 17 is a perspective view of an imaging element; and

FIG. 18A and FIG. 18B are views showing the formation of a wafer image.

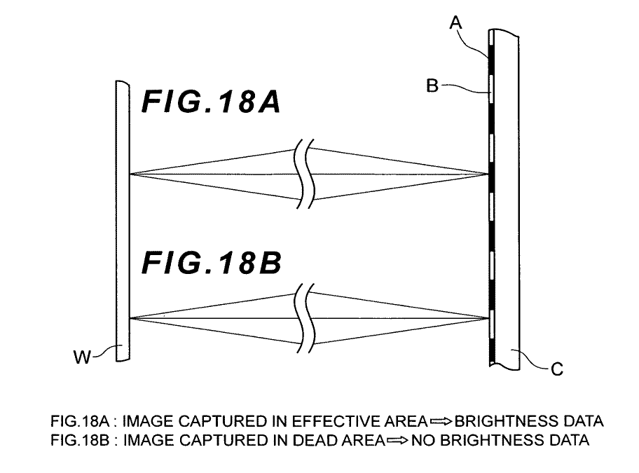

### DESCRIPTION OF THE EMBODIMENTS

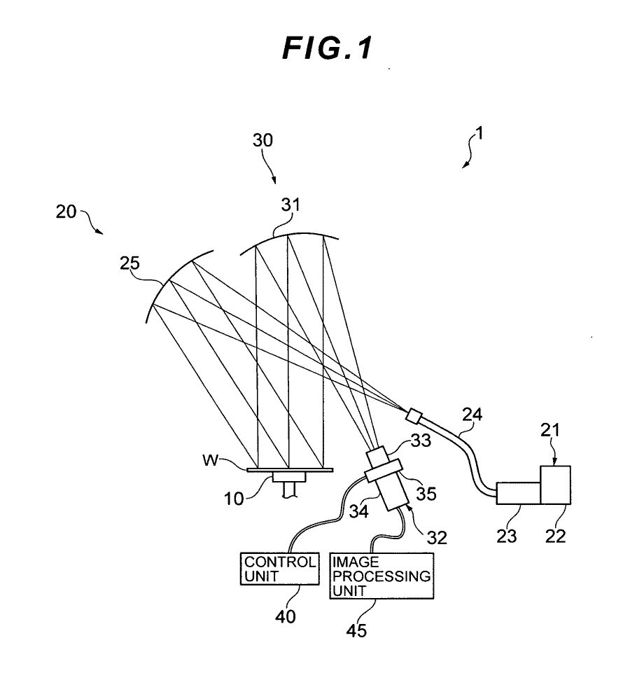

The following is a description of preferred embodiments of the present invention with reference to the drawings. The surface inspection device in the first embodiment is shown in FIG. 1. This apparatus inspects the surface of a semiconductor wafer W (referred to below simply as the wafer W), which is the inspected substrate. A surface inspection device 1 in the first embodiment is equipped with a stage 10 for supporting the substantially disc-shaped wafer W. A wafer W transported by a transport device (not shown) is mounted on the stage 10 and held in place using vacuum suction. The stage 10 rotatably supports the wafer W (rotating the surface of the wafer W) using the rotationally symmetrical axis of the wafer W (the central axis of the stage 10) as the rotational axis. The stage 10 can tilt (incline) the wafer W centered on an axis passing through the surface of the wafer W so as to be able to adjust the angle of incidence of the illumination light.

The surface inspection device 1 also includes an illumination system 20 for illuminating the surface of the wafer W supported by the stage 10 with parallel light (ultraviolet light), a light reception system 30 for collecting the diffracted light from the wafer W when the illumination light is received, a DUV camera 32 for receiving the light collected by the light reception system 30 and capturing an image of the surface of the wafer W, a control unit 40, and an image processing unit 45. The illumination system 20 has an illumination unit 21 for emitting illumination light, and an illumination side concave mirror 25 for reflecting the illumination light emitted from the illumination unit 21 towards the surface of the wafer W. The illumination unit 21 has a light source unit 22 such as a metal halide lamp or mercury lamp, a dimming unit 23 for extracting the light from the light source unit 22 with wavelengths in the ultraviolet range and adjusting the intensity of the light, and a guiding optical fiber 24 for guiding the light from the dimming unit 23 serving as the illumination light to the illumination side concave mirror 25.

The light from the light source unit 22 passes through the dimming unit 23; ultraviolet light with a wavelength in the ultraviolet range (e.g., a wavelength of 248 nm) is emitted as the illumination light from the guiding optical fiber 24 to the illumination side concave mirror 25; and, since the exit part of the guiding optical fiber 24 is arranged in the focal plane of the illumination side concave mirror 25, the illumination light emitted from the guiding optical fiber 24 to the illumination side concave mirror 25 is formed into parallel light beams by the illumination side concave mirror 25 and emitted to the surface of the wafer W supported by the stage 10. The relationship between the angle of incidence and the exit angle of the illumination light relative to the wafer W can be adjusted by tilting (inclining) the stage 10 and changing the mounting angle of the wafer W.

The light (diffracted light) exiting from the surface of the wafer W is collected by the light reception system 30. The light reception system 30 is primarily composed of a light-receiving side concave mirror 31 arranged to face the stage 10. The emitted light (diffracted light) collected by the light-receiving side concave mirror 31 reaches the imaging surface formed in the camera unit 34 via the objective lens 33 of the DUV camera 32, and an image of the wafer W (diffracted image) is captured.

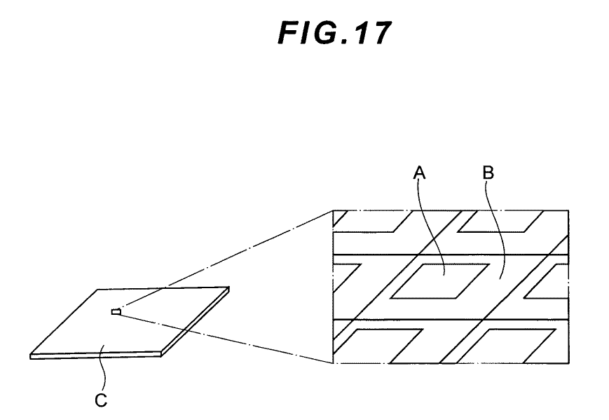

The DUV camera 32 has the objective lens 33 and camera unit 34 mentioned above, as well as a pixel compensation drive unit 35. The objective lens 33 works with the light-receiving side concave mirror 31 mentioned above to collect the light (diffracted light) exiting from the surface of the wafer W on the imaging surface of the camera unit 34 and to capture an image (diffraction image) of the surface of the wafer W on the imaging surface. The camera unit 34 has the imaging element C shown in FIG. 17, and the imaging surface is formed on the surface of this imaging element C. The imaging element C photoelectrically converts the image of the surface of the wafer W formed on the imaging surface into image signals, and outputs the image signals to the image processing unit 45. The pixel compensation drive unit 35 uses a piezo element (piezoelectric element), and is able to move the camera unit 34 with the imaging element C parallel to the imaging surface in perpendicular directions (two axial directions). Because the imaging element C can be moved in this way relative to the optical axis of the light reception system 30, the image of the wafer W captured on the imaging surface can be moved relative to the imaging element C along the imaging plane. If the pixel compensation drive unit 35 having a piezo drive device moves the imaging element C by an amount of movement smaller than the spacing between the pixels constituting the imaging elements C, an image of the wafer W can be captured using pixel compensation.

The control unit 40 controls the movement of the pixel compensation drive unit 35 and the imaging element C in the DUV camera 32, as well as other components such as the stage 10. The image processing unit 45 generates a digital image of the wafer W based on the image signals of the wafer W inputted from the imaging element C in the DW camera 32. Image data of a good wafer is stored in advance in the internal memory (not shown) of the image processing unit 45. When the image processing unit 45 generates an image of the wafer W (digital image), the image data of the wafer W is compared to the image data of a good wafer, and the surface of the wafer W is inspected for defects (abnormalities). The inspection results from the image processing unit 45 and the image of the wafer W at the time are then outputted and displayed on an image display device (not shown).

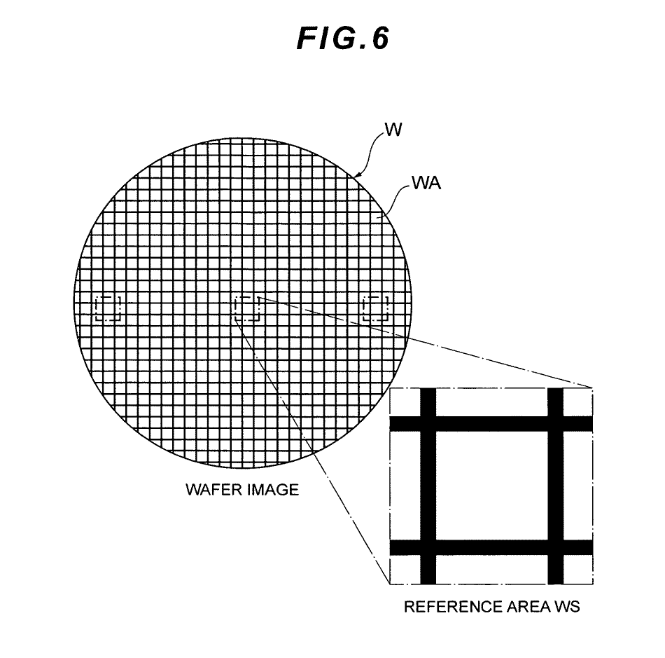

However, after the uppermost resist film has been exposed and developed, a wafer W is transported by a transport system (not shown) from a wafer cassette (not shown) or a developing device to the top of the stage 10. At this time, the wafer W is transported to the top of the stage 10 having been aligned with reference to the pattern on the wafer W or the outer edge (using a notch or an orientation flat). As shown in FIG. 6, a plurality of chip areas WA (shots) are arrayed vertically and horizontally on the surface of the wafer W, and a repetitive pattern (not shown) such as a line pattern or hole pattern is formed in each of the chip areas WA.

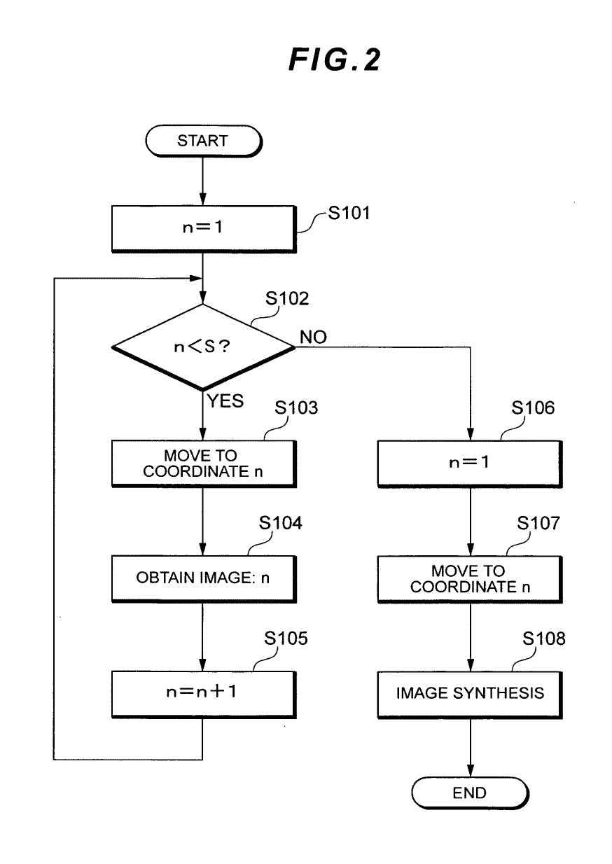

During surface inspection of the wafer W, a surface inspection device 1 with the configuration described above first uses the control unit 40 to have the pixel compensation drive unit 35 move the imaging element C (camera unit 34) in a direction parallel to the imaging surface of the light reception system 30 by an amount of movement smaller than the spacing between the pixels constituting the imaging element C, while the imaging element C captures a plurality of images of the surface of the wafer W (i.e., during pixel compensation). The following is a description of the process performed in order to capture images of the surface of the wafer W during pixel compensation with reference to the flowchart shown in FIG. 2.

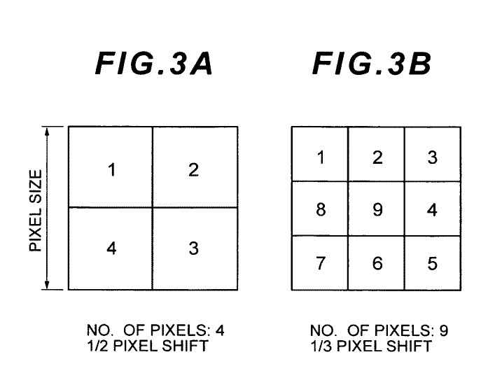

First, n=1 is set (Step S101). Next, it is determined whether or not n is smaller than the number of steps S (Step S102). Because the number of steps S here is j×j where j is the number of pixel divisions, S=4 when pixel compensation is performed with a ½ pixel shift, and S=9 when pixel compensation is performed with a ⅓ pixel shift. Also, n is the order (number) in which images of the surface of the wafer W are taken during pixel compensation. An example of the order for taking images of the surface of the wafer W during pixel compensation is shown in FIG. 3. In FIG. 3A, there is a ½ pixel shift. Here, the pixel compensation drive unit 35 moves the imaging element C by an amount of movement equal to ½ of a pixel constituting the imaging element C. In FIG. 3B, there is a ⅓ pixel shift. Here, the pixel compensation drive unit 35 moves the imaging element C by an amount of movement equal to ⅓ of a pixel constituting the imaging element C. When images of the surface of the wafer W are taken in this order, the imaging element C is moved so as to make a single stroke. This eliminates the effects of hysteresis and backlash, and improves position control. Also, the imaging element C moves more efficiently, and the amount of time required to take images can be reduced. The order in which images of the surface of a wafer W are taken during pixel compensation does not have to be in one of the orders shown in FIG. 3.

When the determination is Yes in Step S102, the process advances to Step S103, and the pixel compensation drive unit 35 moves the imaging element C to the coordinates corresponding to the nth pixel compensation position. Then, the imaging element C takes an image of the surface of the wafer W at the nth pixel compensation position (Step S104). After n has been incremented by one (Step S105), the process returns to Step S102. At this time, the stage 10 is caused to rotate so that the illumination direction on the surface of the wafer W is aligned with the repeating direction of the pattern, and the desired settings are selected based on Huygens' principle to satisfy Equation (1) below (the stage 10 is tilted). The letter P represents the pitch of the pattern, λ is the wavelength of the light illuminating the surface of the wafer W, θ1 is the angle of incidence of the illumination light, and θ2 is the exit angle of the nth diffracted light.

P=n×λ/{sin(θ1)−sin(θ2)} (1)

When illumination light is directed at the surface of the wafer W under these conditions, the light from the light source unit 22 in the illumination unit 21 passes through the dimming unit 23, ultraviolet light with a wavelength in the ultraviolet range (e.g., a wavelength of 248 nm) is emitted as the illumination light from the guiding optical fiber 24 to the illumination side concave mirror 25, and the illumination light reflected by the illumination side concave mirror 25 is directed as parallel light beams towards the surface of the wafer W. The diffraction light exiting from the surface of the wafer W is collected by the light-receiving side concave mirror 31, and reaches the imaging surface of the imaging element C via the objective lens 33. An image of the surface of the wafer W is formed from the diffraction light. The image of the wafer W formed on the imaging surface is then taken by the imaging element C. At this time, the image of the wafer W formed on the imaging surface is photoelectrically converted to image signals, and the image signals are outputted to the image processing unit 45.

When the determination is No in Step S102, the imaging element C has captured an image of the surface of the wafer W at all of the pixel compensation positions. The process advances to Step S106, where n=1 is set. In Step S107, the pixel compensation drive unit 35 moves the imaging element C to the coordinates corresponding to the nth (1st) pixel compensation position.

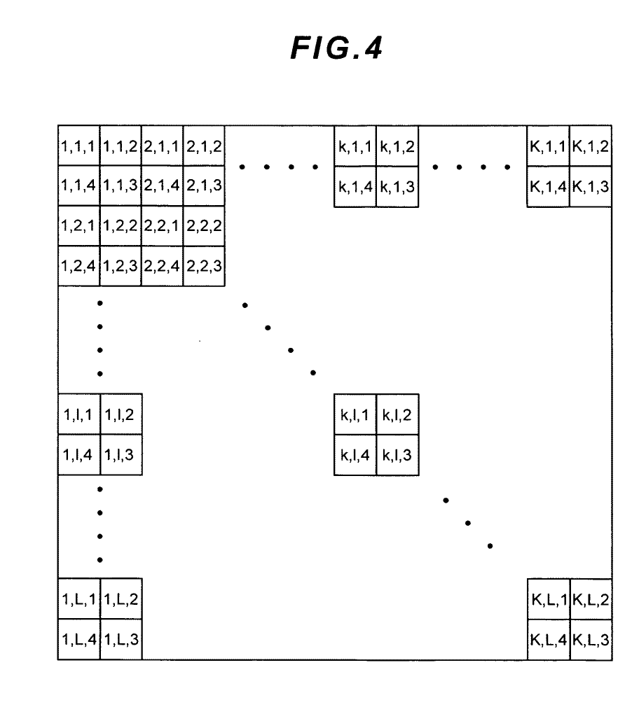

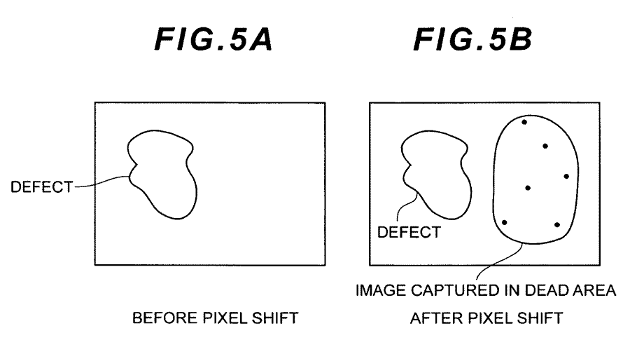

In Step S108, the image processing unit 45 generates a synthesized image of the wafer W based on the plurality of wafer W images taken by the imaging elements C at all of the pixel compensation positions, and the process is ended. At this time, the image processing unit 45 arranges and synthesizes the pixels in the plurality of wafer W images taken by the imaging element C at all of the pixel compensation positions in the order in which they were taken during pixel compensation to generate a synthesized image of the wafer W. For example, when pixel compensation was performed with a ½ pixel shift and, as shown in FIG. 4, the coordinates of a certain pixel in an image of K×L pixels taken in the nth (n=1-4) step are (k, l, n), four pixels are arranged and synthesized (in the captured order) as shown in FIG. 4 to reproduce the brightness data of the images taken in the dead zone (on the imaging surface) of the imaging element C as shown in FIG. 5B. When pixel compensation was performed with the ½ pixel shift shown in FIG. 4, the number of pixels in the synthesized image is 2K×2L pixels (four times the number of pixels when taken).

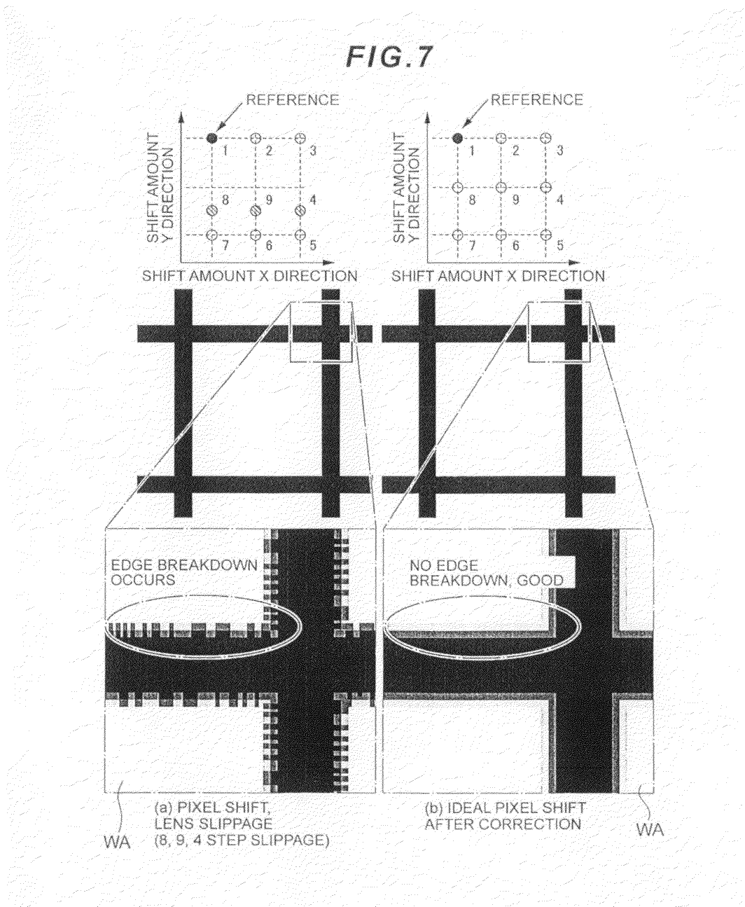

When images of a wafer W are taken in this manner, image information taken in the dead zone of the imaging element C at times cannot be obtained unless the amount by which the imaging element C was moved by the pixel compensation drive unit 35 (the amount of pixel compensation) is corrected. Also, when the edge of a chip area is included in the image, there is uneven gradation in the image of the edge (lost brightness information in the dicing street portion) unless the amount of pixel compensation is corrected. This causes deterioration in the quality of the synthesized image such as the edge becoming unnaturally jagged as shown in FIG. 7A. In order to avoid this, prior to the inspection of the wafer W, an image of the surface of the wafer W is taken with the pixel compensation described above, and the actual amount of pixel compensation (amount of movement by the imaging element C) performed by the pixel compensation drive unit 35. The difference between the target or ideal amount of pixel compensation (amount of movement by the imaging element C) and the actual amount of pixel compensation (amount of movement by the imaging element C) is determined, and the amount of control (drive signals) performed by the control unit 40 on the pixel compensation drive unit 35 is corrected until this difference is eliminated and the appropriate amount of pixel compensation drive is realized.

More specifically, the image taken in the 1st (n=1) step is used as the reference image, and the three areas demarcated by the dotted lines in FIG. 6 are used as reference areas WS (one reference area in the center of the wafer W and one on both the left and right periphery). An edge of the pattern in the resulting image is obtained as a gradation image based on the optical performance of the light reception system 30 and the formation characteristics during pattern formation. In other words, pixels lined up in a direction perpendicular to the direction in which the edge extends have a change in brightness among the pixels in the patterned portion and unpatterned portion. In this embodiment, the position of the edge is determined on the subpixel level based on the change in brightness during image processing. Next, the displacement of the reference areas WS in the images taken in the 2nd and subsequent steps relative to the reference areas WS in the reference image (i.e., the amount of pixel compensation) is measured during image processing. At this time, difference in brightness between the chip area of the wafer W and a dicing street is used to detect the position of the edge of a chip area in the reference area WS on the subpixel level using image processing. As in the case of the reference image, the image displacement of the reference areas WS is determined in the various steps from the amount of edge displacement.

Then, the difference between the image displacement (amount of pixel compensation) in the various steps and the ideal image displacement (amount of pixel compensation) is calculated, and the amount of control performed by the control unit 40 on the pixel compensation drive unit 35 (drive signals in two axial direction) is corrected to eliminate this difference. Also, the amount of image displacement is determined in the three reference areas WS, and the pixel compensation precision can be improved by performing satisfactory corrections in these three reference areas WS. These corrections are performed in both the X and Y axial drive directions. Because the alignment of pixels in the imaging element C can be parallel to the drive direction of the pixel compensation drive unit 35, the imaging sensitivity for the surface of the wafer W is uniform. As shown in FIG. 7B, a synthesized image can thus be obtained with very little edge jaggedness and very few errors. In order to improve the measurement precision for the pixel compensation amount, two of the reference areas WS have to be set at least on the left and right periphery of the wafer W. Reference areas WS can also be set in the center of a wafer W, on the left and right periphery, and on the upper and lower periphery (five areas).

When the image processing unit 45 has generated a synthesized image of the wafer W based on a plurality of wafer W images taken with the imaging element C during pixel compensation as described above, the image processing unit 45 compares the image data of the wafer W with image data of a good wafer to determine whether or not the surface of the wafer W has any defects (abnormalities). The inspection results from the image processing unit 45 and the image (synthesized image) of the wafer W at the time are then outputted and displayed on an image display device (not shown).

However, as mentioned above, in a surface inspection device necessitating the use of an imaging element with a small aperture ratio for shorter wavelength light, the aperture ratio of the imaging element is smaller. As a result, the dead zone is larger, the area with missing information on the image captured on the imaging surface is larger, image reproducibility is poorer, and inspection precision is lower. Also, because very little light reaches the light-receiving unit in the imaging element, the light reception sensitivity is low, and the amount of diffraction light generated by the pattern is low because of the miniaturization of the pitch of the pattern. This doubles the reduction in sensitivity to the inspection signals. When the exposure time of the imaging unit is extended to obtain inspection images able to be used in an inspection, adverse effects occur such as reduced sensitivity due to noise and reduce throughput. When attempts have been made to manufacture an imaging element with improved light reception sensitivity, the scale of development and manufacturing costs have been prohibitive.

In contrast, in the surface inspection device 1 of the first embodiment, the image processing unit 45 generates a synthesized image of the wafer W based on a plurality of wafer W images taken by the imaging element C during pixel compensation. Because the brightness data for images captured in the dead zone (of the imaging surface) of the imaging element C can be reproduced in an image in this way, the effect of the dead zones can be reduced and inspection precision improved.

When the imaging element C is moved in a direction parallel to the imaging surface of the light reception system 30 by the pixel compensation drive unit 35, the relative movement of the image of the wafer W captured on the imaging surface can be moved relative to the imaging element C with precision (pixel compensation can be performed with precision).

Also, the image processing unit 45 can obtain a synthesized image with few errors because the amount of control performed by the control unit 40 on the pixel compensation drive unit 35 can be corrected to eliminate the difference between the actual pixel compensation amount (amount of relative movement) and the ideal target pixel compensation amount (amount of relative movement), and the direction in which the pixels are arrayed for the imaging element C is parallel to the drive direction of the pixel compensation drive unit 35.

When at this time the actual amount of pixel compensation (amount of relative movement) is measured by setting a plurality of reference areas WS in the wafer W image and determining the positions of the reference areas WS in the plurality of wafer W images taken during pixel compensation, the actual amount of pixel compensation can be measured with precision.

In the first embodiment described above, the drive amount of the pixel compensation drive unit 35 is corrected in order to realize adequate pixel compensation drive. However, the present invention is not limited to this. For example, in addition to the pixel compensation drive unit 35, the amount of rotational drive for the stage 10 can also be corrected.

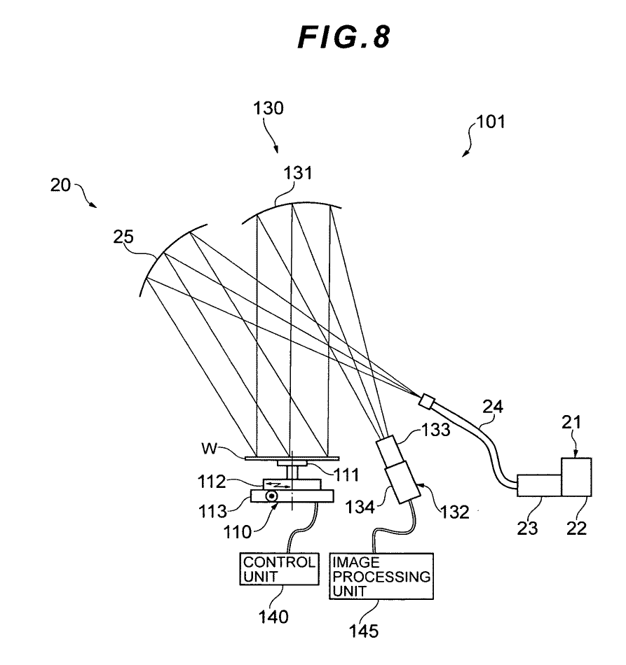

The following is a description of the surface inspection device in the second embodiment. As shown in FIG. 8, the surface inspection device 101 in the second embodiment has a stage unit 110 for supporting a wafer W, an illumination system 20 for illuminating with parallel light (ultraviolet light) the surface of the wafer W supported by the stage unit 110, a light reception system 130 for collecting diffracted light from the wafer W when exposed to the illumination light, a DW camera 132 for receiving the light collected by the light reception system 130 and capturing an image of the surface of the wafer W, a control unit 140, and an image processing unit 145.

The stage unit 110 has a e stage 111, an X stage 112, and a Y stage 113. A wafer W transported by a transport device (not shown) is mounted on the θ stage 111 and held in place using vacuum suction. The θ stage 111 rotatably supports the wafer W (rotating the surface of the wafer W) using the rotationally symmetrical axis of the wafer W (the central axis of the θ stage 111) as the rotational axis. The θ stage 111 can tilt (incline) the wafer W centered on an axis passing through the surface of the wafer W so as to be able to adjust the angle of incidence of the illumination light. The X stage 112 supports the θ stage 111 so that it can move left and right in FIG. 8. The Y stage 112 supports the θ stage 111 and the X stage 112 so that they can move forward and backward in FIG. 8. In other words, the X stage 112 and the Y stage 113 can move the wafer W supported by the θ stage 111 left, right, forward, and backward on a substantially horizontal plane.

The illumination system 20 is configured in the same manner as the illumination system 20 in the first embodiment. This component is denoted by the same reference number, and a detailed explanation has been omitted. The light reception system 130 is primarily composed of a light-receiving side concave mirror 131 arranged facing the stage unit 110 (θ stage 111). Light (diffraction light) collected by the light-receiving side concave mirror 131 reaches the imaging surface formed in the camera unit 134 via the objective lens 133 in the DUV camera 132 and an image of the wafer W is captured. Because the light-receiving side concave mirror 131 faces the stage unit 110 (θ stage 111), the X stage 112 and the Y stage 113 can move the wafer W supported by the θ stage 111 in a direction (two axial directions) perpendicular to the optical axis of the light reception system 130 so that the image of the wafer W captured on the imaging surface can be moved on the imaging plane relative to the imaging element C. Thus, if the image of the wafer W, is shifted by an amount of movement smaller than the spacing between the pixels constituting the imaging element C, an image of the wafer W can be captured using pixel compensation.

The DUV camera 132 has the objective lens 133 and camera unit 134 mentioned above. The objective lens 133 works with the light-receiving side concave mirror 131 mentioned above to collect the light (diffracted light) exiting from the surface of the wafer W on the imaging surface of the camera unit 134 and to capture an image of the surface of the wafer W on the imaging surface. The camera unit 134 has the imaging element C shown in FIG. 17, and the imaging surface is formed on the surface of this imaging element C. The imaging element C photoelectrically converts the image of the surface of the wafer W formed on the imaging surface into image signals, and outputs the image signals to the image processing unit 145.

The control unit 140 controls the operation of the imaging element C in the DUV camera 132 as well as components such as the stage unit 110. The image processing unit 145 generates a synthesized image of the wafer W in the same manner as the first embodiment based on image signals of the wafer W outputted from the imaging element C in the DUV camera 132, and the surface of the wafer W is inspected for defects (abnormalities) in the same manner as the first embodiment based on the resulting synthesized image of the wafer W.

In the surface inspection device 101 of the second embodiment with the configuration described above, instead of the pixel compensation drive unit 35 in the first embodiment, the X stage 112 and the Y stage 113 are used to move the wafer W supported by the θ stage 111 in the directions (two axial directions) parallel to the conjugate plane of the imaging surface of the light reception system 130 to move the image of the wafer W captured on the imaging surface on the imaging plane relative to the imaging element C. The control unit 140 moves the wafer W supported by the θ stage 111 in the directions (two axial directions) parallel to the conjugate plane of the imaging surface of the light reception system 130 while the imaging element C obtains a plurality of images of the surface of the wafer W in the same manner as the first embodiment (i.e., during pixel compensation). Then, the image processing unit 145 in the same manner as the first embodiment generates a synthesized image of the wafer W based on the plurality of wafer W images taken by the imaging element C during pixel compensation. The surface of the wafer W is then inspected for defects (abnormalities) based on the resulting synthesized image of the wafer W. The inspection results from the image processing unit 145 and the image of the wafer W at the time are then outputted and displayed on an image display device (not shown).

As a result, results similar to those in the first embodiment can be obtained from the surface inspection device 101 of the second embodiment. Because the image of the surface of the wafer W captured on the imaging surface is magnified by the light reception system 130 relative to the physical surface of the wafer W, the control unit 140 controls the operation of the X stage 112 and the Y stage 113 so that the amount of movement by the a θ stage 111 is calculated from the amount of relative movement of the image of the wafer W with respect to the imaging element C (i.e., the amount of pixel compensation) based on the imaging magnification of the light reception system 130. More specifically, the θ stage 111 is moved by β×L/j, where the imaging magnification of the light reception system 130 is β, the size of the pixels constituting the imaging element C is L, and the number of pixel divisions is j. If the X stage 112 and the Y stage 113 are used in this way to move the wafer W supported by the θ stage 111 in a direction perpendicular to the optical axis of the light reception system 130, the image of the wafer W can be moved relative to the imaging element C using a comparatively simple configuration.

Also, in the second embodiment, in order to realize adequate pixel compensation drive, the amount of control performed by the control unit 140 on the X stage 112 and the Y stage 113 is controlled instead of the pixel compensation drive unit 35 in the first embodiment. In addition to correcting the X stage 112 and the Y stage 113, the amount of rotation drive for the θ stage 111 can also be corrected.

In the first and second embodiments, the diffracted light occurring on the surface of the wafer W is used to inspect the surface of the wafer W. However, the present invention is not limited to this. For example, scattered light occurring on the surface of the wafer W can be used by the surface inspection device to inspect the surface of the wafer W.

In the first and second embodiments mentioned above, the surface of a wafer W is inspected. However, the present invention is not limited to this. It can also be used, for example, to inspect the surface of a glass substrate.

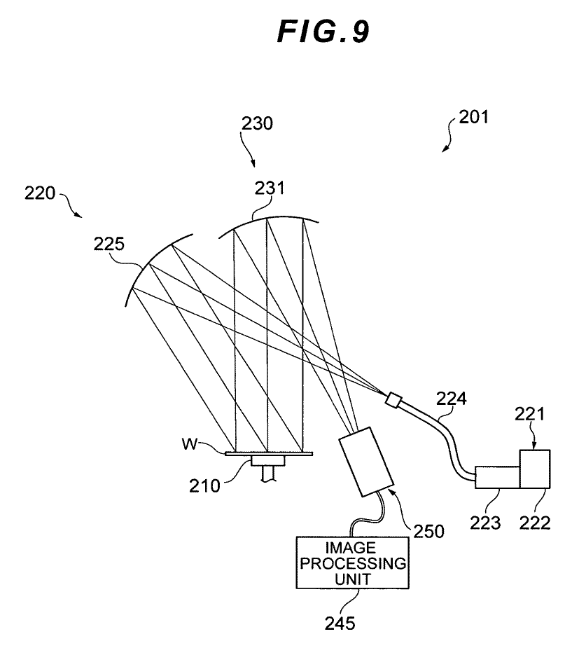

The following is a description of the surface inspection device in the third embodiment of the present invention. The surface inspection device in the third embodiment is shown in FIG. 9. This device is used to inspect a semiconductor wafer W serving as a semiconductor substrate (referred to as “wafer W” below). The surface inspection device 201 in the third embodiment is equipped with a stage 210 for supporting a substantially disc-shaped wafer W. A wafer W transported by a transport device (not shown) is mounted on the stage 210 and held in place using vacuum suction. The stage 210 supports the wafer W rotatably (rotating the surface of the wafer W) using the rotationally symmetrical axis of the wafer W (the central axis of the stage 210) as the rotational axis. The stage 210 can tilt (incline) the wafer W centered on an axis passing through the surface of the wafer W so as to be able to adjust the angle of incidence of the illumination light.

The surface inspection device 201 also includes an illumination system 220 for illuminating the surface of the wafer W supported by the stage 210 with parallel light (ultraviolet light), a light reception system 230 for collecting the diffracted light from the wafer W when the illumination light is received, a DUV camera 250 for receiving the light collected by the light reception system 230 and capturing an image of the surface of the wafer W, and an image processing unit 245. The illumination system 220 has an illumination unit 221 for emitting illumination light, and an illumination side concave mirror 225 for reflecting the illumination light emitted from the illumination unit 221 towards the surface of the wafer W. The illumination unit 221 has a light source unit 222 such as a metal halide lamp or mercury lamp, a dimming unit 223 for extracting the light from the light source unit 222 with wavelengths in the ultraviolet range and adjusting the intensity of the light, and a guiding optical fiber 224 for guiding the light from the dimming unit 223 serving as the illumination light to the illumination side concave mirror 225.

The light from the light source unit 222 passes through the dimming unit 223, ultraviolet light with a wavelength in the ultraviolet range (e.g., a wavelength of 248 nm) is emitted as the illumination light from the guiding optical fiber 224 to the illumination side concave mirror 225; and, since the exit part of the guiding optical fiber 224 is arranged in the focal plane of the illumination side concave mirror 225, the illumination light emitted from the guiding optical fiber 224 to the illumination side concave mirror 225 is formed into parallel light beams by the illumination side concave mirror 225 and emitted to the surface of the wafer W supported by the stage 210. The relationship between the angle of incidence and the exit angle of the illumination light relative to the wafer W can be adjusted by tilting (inclining) the stage 210 and changing the mounting angle of the wafer W.

The light (diffracted light) exiting from the surface of the wafer W is collected by the light reception system 230. The light reception system 230 is primarily composed of a light-receiving side concave mirror 231 arranged to face the stage 210. The emitted light (diffracted light) collected by the light-receiving side concave mirror 231 reaches the imaging surface of a DUV imaging device 250, and an image of the wafer W (diffracted image) is captured.

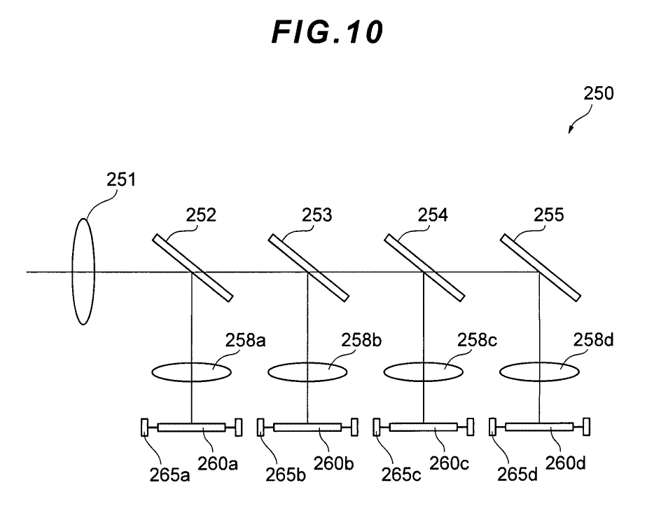

The DUV imaging device 250, as shown in FIG. 10, has a lens group 251, three beam splitters 252-254, a mirror 255, four imaging lenses 258a-258d, and four imaging members 260a-260d. When the light (diffracted light) exiting from the surface of the wafer W and reflected by the light-receiving side concave mirror 231 is incident on the DW imaging device 250, it passes through the lens group 251 and becomes parallel light. The parallel light (diffracted light) obtained by passage through the lens group 251 is then incident on the first beam splitter 252. At this time, ¼ of the incident parallel light is reflected by the first beam splitter 252, collected by the first imaging lens 258a, and imaged on the imaging surface of the first imaging member 260a. Also, ¾ of the incident parallel light passes through the first beam splitter 252, and is incident on the second beam splitter 253. At this time, ⅓ of the incident parallel light is reflected by the second beam splitter 253, collected by the second imaging lens 258b, and imaged on the imaging surface of the second imaging member 260b.

Also, ⅔ of the parallel light incident on the second beam splitter 253 passes through the second beam splitter 253, and is incident on the third beam splitter 254. At this time, ½ of the incident parallel light is reflected by the third beam splitter 254, collected by the third imaging lens 258c, and is imaged on the imaging surface of the third imaging member 260c. Here, ½ of the parallel light incident on the third beam splitter 254 passes through the third beam splitter 254 is nearly 100% reflected by the mirror 255, is collected by the fourth imaging lens 258d, and is imaged on the imaging surface of the fourth imaging member 260d. The first through third beam splitters 252-254 can be half mirrors in which a metal film and dielectric film have been deposited on parallel glass substrates to obtain the desired characteristics. The mirror 255 can be a mirror in which metal film has been deposited on a glass substrate.

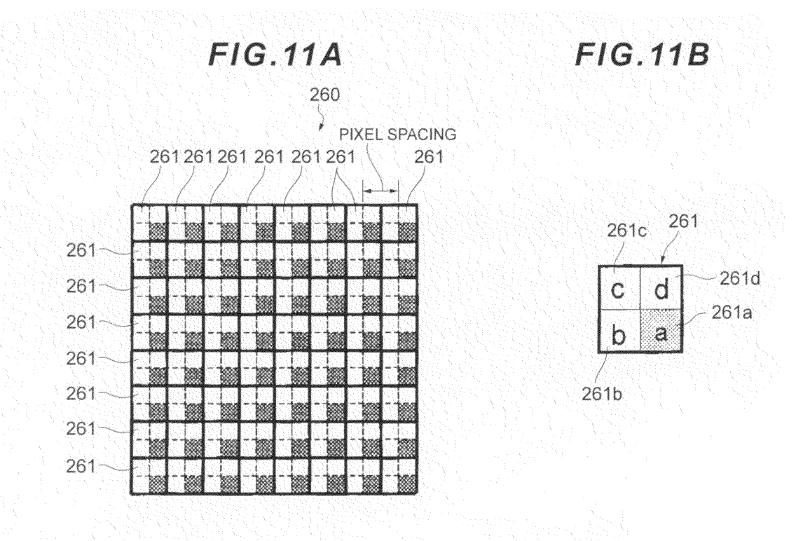

The surfaces of the four imaging members 260a-260d form the imaging surface. Each of the imaging members 260a-260d photoelectrically converts the image of the wafer W formed on the imaging surface to generate image signals, and these image signals are outputted to the image processing unit 245. The following is a description of the positional relationship between the image of the wafer W captured on the imaging surfaces of the four imaging members 260a-260d (below referred to simply as imaging member 260) and the imaging member 260. FIG. 11A is a schematic view of the imaging member 260, and FIG. 11B is a view showing the light-receiving area 261a which actually receives light and the dead zones 261b-261d in a pixel area 261 of the imaging member 260. In other words, a pixel area 261 is shown in FIG. 11B, and these form the light-receiving surface (imaging surface) of the imaging member 260 shown in FIG. 11A. In FIG. 11 through FIG. 13, for the sake of convenience, the area in the lower right of the pixel area 261 is always shown as the light-receiving area 261a. Each pixel area 261 corresponds to each pixel of the imaging member 260.

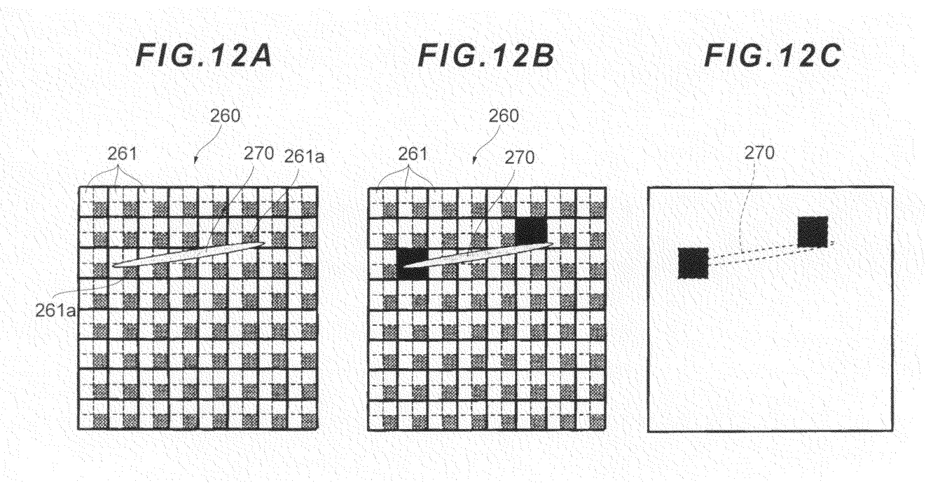

The following is an explanation with reference to FIG. 12 of an example in which a microscopic defect is imaged on the imaging surface of the imaging member 260. FIG. 12 is a schematic view showing an image of a microscopic defect 270 captured on the imaging member 260. It is clear from FIG. 12A that an image signal of the defect 270 can be generated because both ends of the defect 270 are in light-receiving areas 261a, but no image signals can be generated for the other portions since they are not in the light-receiving areas 261a. During actual imaging, it is determined whether there is an image in a pixel area 261 when an image signal is generated by a light-receiving area 261a. As a result, the image signals are generated as shown in FIG. 12B (from the black pixel areas 261), and the image generated by the image processing unit 245 as shown in FIG. 12C is the final image. The resulting shape (as seen in the black portions) ends up being altogether different from that of the defect 270.

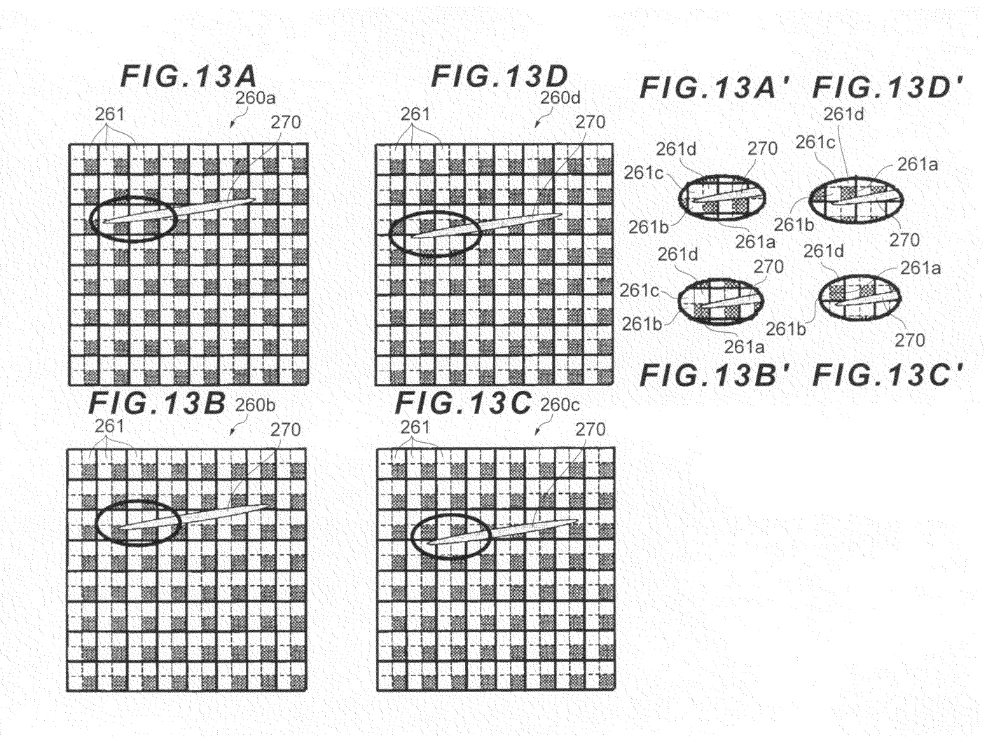

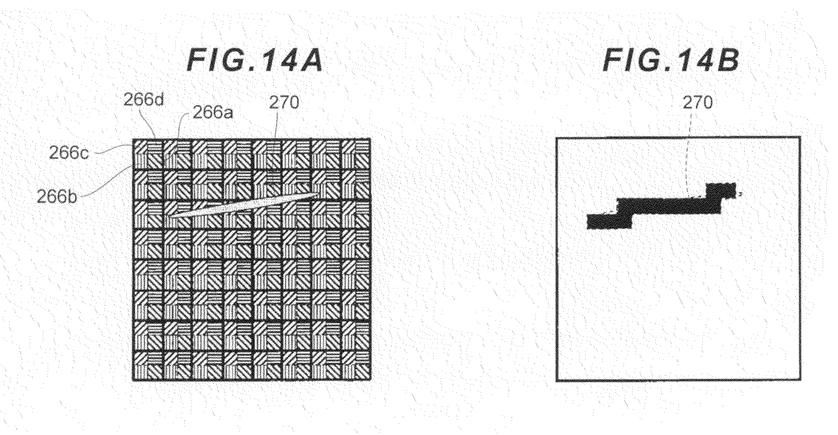

In this embodiment, the four imaging members 260a-260d are arranged relative to the image of the wafer W so that the image of the wafer W is shifted by ½ the pixel spacing and captured. The pixel spacing is the interval (or pitch) between the centers of the pixel areas 261 which are adjacent with each other. The arrangement of the imaging members 260a-260d will now be explained in greater detail with reference to FIG. 13 and FIG. 14. FIG. 13A shows the positional relationship between the defect 270 and the pixels in the first imaging member 260a. Similarly, FIG. 13B shows the positional relationship between the defect 270 and the pixels in the second imaging member 260b, FIG. 13C shows the positional relationship between the defect 270 and the pixels in the third imaging member 260c, and FIG. 13D shows the positional relationship between the defect 270 and the pixels in the fourth imaging member 260d. FIGS. 13A′-D′ show oval-shaped cutouts from FIGS. 13A-D. As is clear from these drawings, the four imaging members 260a-260d are arranged so that each one is shifted ½ of a pixel spacing relative to the image of the wafer W; therefore, the dead zones 261b-261d in each of the imaging members 260a-260d have been compensated for.

As shown in FIG. 10, the first through fourth imaging members 260a-260d are held, respectively, by a first through fourth retention mechanism 265a-265d allowing for positional adjustment (in a direction perpendicular to the optical axis). These retention mechanisms 265a-265d can be set and adjusted so that they are shifted only ½ of a pixel spacing (to compensate for the dead zones 261b-261d in each of the imaging members 260a-260d); however, such a configuration is not given by way of limitation to the present invention. The first through fourth imaging members 260a-260d can be retained so that each one is shifted ½ of a pixel spacing in advance by a retention component (not shown).

FIG. 14 is a view showing image processing performed by the image processing unit 245. FIG. 14A is an image in which the pixel areas 261 shown in FIGS. 13A-D have been synthesized. In FIG. 14A, the area 266a with cross-hatching extending from the upper left to the lower right in FIG. 14A corresponds to the light-receiving area 261a of the first imaging member 260a, the area 266b with vertical lines in FIG. 14A corresponds to the light-receiving area 261a of the second imaging member 260b, the area 266c with cross-hatching extending from the upper right to the lower left in FIG. 14A corresponds to the light-receiving area 261a of the third imaging member 260c, and the area 266d with horizontal lines in FIG. 14A corresponds to the light-receiving area 261a of the fourth imaging member 260d. Because the image processing unit 245 synthesizes the images obtained from the imaging members 260a-260d with the positional relationships shown in FIG. 14A (i.e., in a positional relationship shifted vertically and horizontally by ½ of a pixel spacing), the dead zones 261b-261d in the imaging members 260a-260d are mutually compensated for, and a synthesized image can be generated as shown in FIG. 14B. It is clear from FIG. 14B that the shape of the defect 270 has been substantially reproduced (as indicated by the black portions).

When the first through third beam splitters 252-254 are half mirrors formed by depositing metal film and dielectric film on parallel glass substrates to obtain the desired characteristics, they are relatively easy to design and manufacture with the desired performance (reflectance, transmittance, etc.) for a single wavelength. However, designing and manufacturing one with the desired characteristics for a plurality of wavelengths requires advanced technology and increases costs. In this case, it is designed and manufactured to obtain the desired characteristics for the most frequently used wavelength (e.g., 365 nm). The reflectance and transmittance for other wavelengths are determined in advance and stored in the image processing unit 245. When an image is synthesized, a good synthesized image can be obtained by adjusting the gain of the various images.

The image processing unit 245 generates a synthesized image of the wafer W with pixel compensation performed as described above based on image signals inputted from the four image components 260a-260d in the DUV imaging device 250. Image data of a good wafer is stored in advance in the internal memory (not shown) of the image processing unit 245. When a synthesized image of a wafer W is generated, the image processing unit 245 compares the image data of the wafer W to the image data for a good wafer to inspect the surface of the wafer W for defects (abnormalities). The inspection results from the image processing unit 245 and the image (synthesized image) of the wafer W at the time are then outputted and displayed on an image display device (not shown).

However, after the uppermost resist film has been exposed and developed, a wafer W is transported by a transport system (not shown) from a wafer cassette (not shown) or a developing device to the top of the stage 210. At this time, the wafer W is transported to the top of the stage 210 having been aligned with reference to the pattern on the wafer W or the outer edge (using a notch or an orientation flat). While a detailed illustration has been omitted, a plurality of chip areas (shots) are arrayed vertically and horizontally on the surface of the wafer W, and a repeating pattern such as a line pattern or hole pattern is formed in each of the chip areas.

During surface inspection of the wafer W, a surface inspection device 201 with the configuration described above first transports the wafer W to the top of the stage 210 using a transport device (not shown). During transport, an alignment mechanism (not shown) is used to obtain position information from the pattern formed on the surface of the wafer W so that the wafer W can be loaded in a predetermined direction at a predetermined position on top of the stage 210.

Next, the stage 210 is rotated so that the illumination direction on the surface of the wafer W is aligned with the repeating direction of the pattern. It is then set (the stage 210 is tilted) . in accordance with Huygens' principle to satisfy Equation (1) below, where the pitch of the pattern is P, the wavelength of the light illuminating the surface of the wafer W is λ, the angle of incidence of the illumination light is θ1, and the exit angle of the nth diffracted light is θ2. Equation (1) has been reproduced below.

P=n×λX/{sin(θ1)−sin(θ2)} (1)

When the surface of the wafer W has been illuminated by the illumination light under these conditions, the light from the light source unit 222 in the illumination unit 221 passes through the dimming unit 223, ultraviolet light with a wavelength in the ultraviolet range (e.g., a wavelength of 248 nm) is emitted as the illumination light from the guiding optical fiber 224 to the illumination side concave mirror 225, and the illumination light reflected by the illumination side concave mirror 225 is directed towards the surface of the wafer W as parallel light beams. The diffracted light exiting from the surface of the wafer W is collected by the light-receiving side concave mirror 231. The collected light is incident on the DUV imaging device 250, and passed through the lens group 251 to become parallel light. The parallel light (diffraction light) obtained by passage through the lens group 251 is split into four parallel light beams by the first through third beam splitters 252-254 and the mirror 255. The four split parallel light beams are collected by the first through fourth imaging lenses 258a-258d, and reach the imaging surfaces of the first through fourth imaging members 260a-260d, where an image of the wafer W is captured.

The first through fourth imaging members 260a-260d photoelectrically convert the image of the surface of the wafer W formed on the imaging surface to generate image signals, and the image signals are outputted to the image processing unit 245. The image processing unit 245 generates a synthesized image of the wafer W on which the pixel compensation described above has been performed based on the image signals inputted from the four imaging members 260a-260d. When a synthetic image of the wafer W has been generated, the image data of the wafer W is compared to image data for a good wafer to inspect the surface of the wafer W for defects (abnormalities). The inspection results from the image processing unit 245 and the image (synthetic image) of the wafer W at the time are then outputted and displayed on an image display device (not shown).

In the surface inspection device 201 of the third embodiment, the image processing unit 245 generates a synthesized image of the wafer W based on the wafer W images taken by a plurality of imaging members 260a-260d arranged so that the dead zones 261b-261d are mutually compensated for during imaging. Because the brightness data for images captured in the dead zone of the imaging members can be reproduced in an image, the effect of the dead zones can be reduced and inspection precision improved.

Because a synthesized image of the wafer W that has undergone pixel compensation can be generated by the image processing unit 245 without having to drive the imaging members 260a-260d, pixel compensation can be performed with a high degree of reliability.

Because the light-receiving area 261a in one of a plurality of imaging members 260a-260d receives an image of light from the surface of the wafer W that reaches the dead zones 261b-261d in the other imaging members, efficient pixel compensation can be performed.

Also, a plurality of images for pixel compensation can be captured all at once by splitting the light from the surface of the wafer W into a plurality of light beams using a first through third beam splitter 252-254 and collecting and capturing the light on the imaging surface of the imaging members 260a-260d using a first through fourth imaging lens 258a-258d.

Four imaging members 260a-260d are preferably used when, as in this embodiment, the imaging members are shifted ½ of a pixel spacing relative to the image of the wafer W.

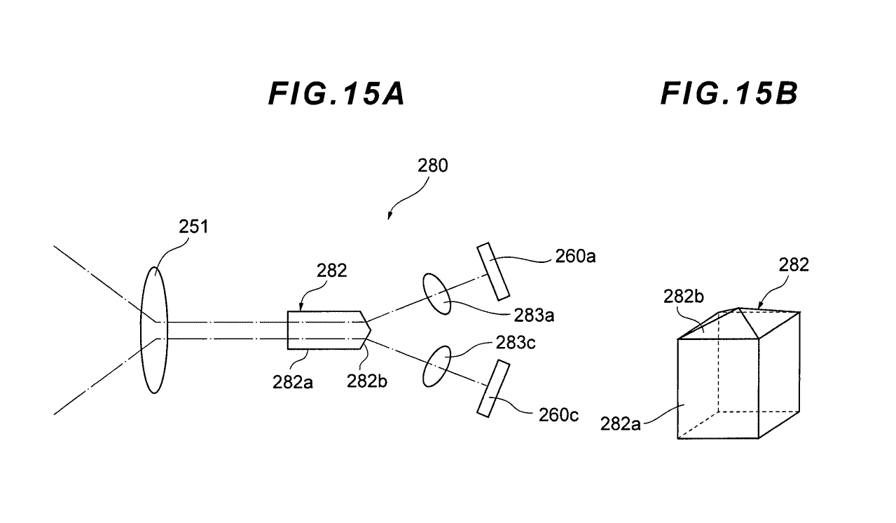

The following is a description of the surface inspection device in the fourth embodiment with reference to FIG. 15. The surface inspection device in the fourth embodiment is identical to the surface inspection device 201 in the third embodiment except for the configuration of the DUV imaging device 250. Because the rest of the configuration is the same, the identical components are denoted by the same reference numbers, and a detailed explanation of these components has been omitted. As shown in FIG. 15A, the DUV imaging device 280 in the fourth embodiment has a lens group 251, a beam splitting optical element 282, four imaging lenses 283a-283d, and four imaging members 260a-260d. Of the four imaging lenses 283a-283d, the second imaging lens 283b and the fourth imaging lens 283d have been omitted from FIG. 15A. Of the four imaging members 260a-260d, the second imaging member 260b and the fourth imaging member 260d have been omitted from FIG. 15A.

In the fourth embodiment, as in the case of the third embodiment, diffraction light exiting from the surface of the wafer W is collected by the light-receiving side concave mirror 231. The collected light is incident on the DUV imaging device 280, and passes through the lens group 251 to become parallel light. The parallel light (diffraction light) obtained from passage through the lens group 251 is incident to the beam splitting optical element 282. The beam splitting optical element 282, as shown in FIG. 15B, is a colorless, transparent, low dispersion, integrated optical element having a shape in which one surface of a rectangular column (the top) is combined with a square pyramid. This beam splitting optical element 282 is arranged so that the direction in which the rectangular column 282a extends (the ridge line continuing from the bottom surface of the square pyramid) is aligned with the traveling direction of the parallel light, and so that the apex of the square pyramid 282b is aligned with the center of the parallel light. As a result, the parallel light incident to the interior of the beam splitting optical element 282 from the bottom surface of the rectangular column 282a is split equally at a predetermined angle and exits from the four side surfaces continuing to the apex of the square pyramid 282b. The four parallel light beams split by and exiting from the beam splitting optical element 282 are collected by the first through fourth imaging lenses 283a-283d and captured on the imaging surface of the first through fourth imaging members 260a-260d.

As in the case of the third embodiment, the first through fourth imaging members 260a-260d are arranged by the retention mechanisms 265a-265d described above so that they are mutually shifted ½ of a pixel spacing relative to the wafer W (so that the dead zones are mutually compensated for during imaging), and the image of the surface of the wafer W formed on the imaging surface is photoelectrically converted to generated image signals. These image signals are outputted to the image processing unit 245. As in the case of the third embodiment, a synthetic image of the wafer W with pixel compensation is generated by the image processing unit 245 based on the image signals inputted from the four imaging members 260a-260d, and the generated synthetic image of the wafer W is used to inspect the surface of the wafer W for defects (abnormalities).

The fourth embodiment can obtain the same effects as the third embodiment in this way. Also, because a beam splitting optical element 282 is used in the fourth embodiment, the light passes through the lens group 251, is split by the beam splitting optical element 282, and reaches the imaging members 260a-260d under the same optical conditions. As a result, the image obtained by the imaging members 260a-260d has the same brightness and is generated in the same manner even when an aberration occurs. Thus, the synthesized image is a good image. Because a half mirror, which is difficult to manufacture, is not used, manufacturing costs can be held down.

The beam splitting optical element 282 is a low dispersion optical element (e.g., fluorite, quartz glass, ED glass, etc.), but the exit angle is sometimes slightly different depending on the wavelength of the light. In order to offset this effect, the apex angle of the square pyramid 282b is preferably increased, and the angle between lines extending from the light exiting from the beam splitting optical element 282 and the parallel light incident to the beam splitting optical element 282 is preferably reduced.

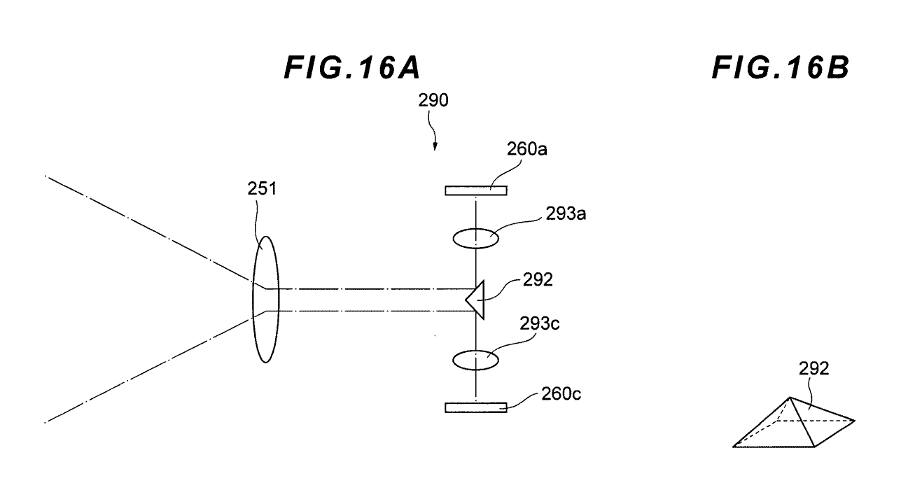

The following is a description of the surface inspection device in the fifth embodiment with reference to FIG. 16. The surface inspection device in the fifth embodiment is identical to the surface inspection device 201 in the third embodiment except for the configuration of the DUV imaging device 250. Because the rest of the configuration is the same, the identical components are denoted by the same reference numbers, and a detailed explanation of these components has been omitted. As shown in FIG. 16A, the DUV imaging device 290 in the fifth embodiment has a lens group 251, a beam splitting mirror element 292, four imaging lenses 293a-293d, and four imaging members 260a-260d. Of the four imaging lenses 293a-293d, the second imaging lens 293b and the fourth imaging lens 293d have been omitted from FIG. 16A. Of the four imaging members 260a-260d, the second imaging member 260b and the fourth imaging member 260d have been omitted from FIG. 16A.

In the fifth embodiment, as in case of the third embodiment, diffraction light exiting from the surface of the wafer W is collected by the light-receiving side concave mirror 231. The collected light is incident to the DUV imaging device 290, and passes through the lens group 251 to become parallel light. The parallel light (diffraction light) obtained from passage through the lens group 251 is incident to the beam splitting mirror element 292. As shown in FIG. 16B, the beam splitting mirror element 292 is an optical element in which a material with a high degree of reflection precision such as silver is deposited using a method such as vapor deposition on the side surfaces of a square pyramidal base with an angle of 45 degrees between the side surfaces and the bottom surface. The side surfaces of the beam splitting mirror element 292 are formed with an extremely high degree of flatness. Because the reflective surfaces have a high degree of flatness, light incident to the beam splitting mirror element 292 can be reflected without scattering. This beam splitting mirror element 292 is arranged so that the bottom surface is perpendicular to the parallel light incident to the beam splitting mirror element 292, and so that the apex is aligned with the center of the parallel light. As a result, parallel light incident to the beam splitting mirror element 292 is split equally by the four side surfaces meeting at the apex, and reflected in a direction perpendicular to the direction of incidence. The four parallel light beams split and reflected by the beam splitting mirror element 292 are collected by the first through fourth imaging lenses 293a-293d and imaged on the imaging surface of the first through fourth imaging members 260a-260d.

As in the case of the third embodiment, the first through fourth imaging members 260a-260d are arranged by the retention mechanisms 265a-265d described above so that they are mutually shifted ½ of a pixel spacing relative to the wafer W (so that the dead zones are mutually compensated for during imaging), and the image of the surface of the wafer W formed on the imaging surface is photoelectrically converted to generated image signals. These image signals are outputted to the image processing unit 245. As in the case of the third embodiment, a synthetic image of the wafer W with pixel compensation is generated by the image processing unit 245 based on the image signals inputted from the four imaging members 260a-260d, and the generated synthetic image of the wafer W is used to inspect the surface of the wafer W for defects (abnormalities).

The fifth embodiment can thus exhibit the same effects as the third embodiment. Also, because a beam splitting mirror element 292 is used in the fourth embodiment, the light passes through the lens group 251, is split by the beam splitting mirror element 292, and reaches the imaging members 260a-260d under the same optical conditions. As a result, the image obtained by the imaging members 260a-260d has the same brightness and is generated in the same manner even when an aberration occurs. Thus, the synthesized image is a good image. Also, because a mirror is used in the fifth embodiment, the light passes through the lens group 251, is split by the beam splitting mirror element 292, and reaches the imaging members 260a-260d under the same optical conditions without any adverse effects due to the wavelength of the light.

A solid-stage imaging element such as a CCD or CMOS can be used as the imaging member. A plurality of solid-state imaging elements can be used to compensate for the dead zones in a solid-state element in the third through fifth embodiments. A solid-state imaging element can be used as an imaging member with a dead zone, even when it has an optical component such as a micro lens array. In the third through fifth embodiments mentioned above, the surface of a wafer W is inspected using diffracted light occurring on the surface of the wafer W; however, such a configuration is not provided by way of limitation to the present invention. In an additional application, the invention can be used in a surface inspection device for inspecting the surface of a wafer W using scattered light occurring on the surface of the wafer W.

In the third through fifth embodiments mentioned above, the surface of a wafer W is inspected; however, such a configuration is not provided by way of limitation to the present invention. The invention can also be used, for example, to inspect the surface of a glass substrate.

### EXPLANATION OF NUMERALS AND CHARACTERS

W Wafer
C Imaging Element
1 Surface inspection device (1st Embodiment)
10 Stage
20 Illumination System (Illumination Unit)
30 Light reception system (Light-Receiving Optical System)
32 DUV Camera
33 Objective Lens
34 Camera Unit
35 Pixel Compensation Drive Unit (Relative Movement Unit)
40 Control Unit
45 Image Processing Unit (Measurement Unit and Correction Unit)
101 Surface inspection device (2nd Embodiment)
110 Stage Unit
111 θStage
112 X Stage (Stage Drive Unit)
113 Y Stage (Stage Drive Unit)
130 Light reception system (Light-Receiving Optical System)
132 DUV Camera
133 Objective Lens
134 Camera Unit
140 Control Unit
145 Image Processing Unit (Measurement Unit and Correction Unit)
201 Surface inspection device (3rd Embodiment)
210 Stage
220 Illumination System (Illumination Unit)
230 Light reception system (Light-Receiving Optical System)
245 Image Processing Unit (Inspection Unit)
250 DUV Imaging Device
252 1st Beam Splitter (Splitting Unit)
253 2nd Beam Splitter (Splitting Unit)
254 3rd Beam Splitter (Splitting Unit)
258a 1st Imaging Lens (Imaging Unit)
258b 2nd Imaging Lens (Imaging Unit)
258c 3rd Imaging Lens (Imaging Unit)
258d 4th Imaging Lens (Imaging Unit)
260a 1st Imaging member
260b 2nd Imaging member
260c 3rd Imaging member
260d 4th Imaging member
261 Pixel Area
261a Light-Receiving Area (Light-Receiving Portion)
261b Dead Zone (Dead Portion)
261c Dead Zone (Dead Portion)
261d Dead Zone (Dead Portion)
265a 1st Retention Mechanism (Setting Unit)
265b 2nd Retention Mechanism (Setting Unit)
265c 3rd Retention Mechanism (Setting Unit)
265d 4th Retention Mechanism (Setting Unit)
280 DUV Imaging Device (4th Embodiment)
282 Beam Splitting Optical Element (Splitting Unit)
283a 1st Imaging Lens (Imaging Unit)
283b 2nd Imaging Lens (Imaging Unit)
283c 3rd Imaging Lens (Imaging Unit)
283d 4th Imaging Lens (Imaging Unit)
290 DUV Imaging Device (5th Embodiment)
292 Beam Splitting Mirror Element (Splitting Unit)
293a 1st Imaging Lens (Imaging Unit)
293b 2nd Imaging Lens (Imaging Unit)
293c 3rd Imaging Lens (Imaging Unit)
293d 4th Imaging Lens (Imaging Unit)

1. A surface inspection device for inspecting a surface of a substrate, the surface inspection device comprising:
a stage for supporting a substrate;
an illumination unit for illuminating with ultraviolet light a surface of the substrate supported by the stage;
a light reception system for receiving light from the surface of the substrate illuminated with ultraviolet light and forming an image of the surface of the substrate;
an imaging element provided with a plurality of pixels, and having an imaging surface in a position for capturing an image imaged by the light reception system, there being provided to the imaging surface a light-receiving portion for receiving and detecting light from the image, and a dead portion for not detecting light, the dead portion established around the light-receiving portion; and
a setting unit for setting a relative position of the imaging element with respect to the image formed on the imaging surface,
the setting unit setting the relative position so that the imaging element captures a plurality of images in a plurality of relative positions offset by an amount of relative movement that is smaller than a spacing between the pixels, and
the surface inspection device comprising an image processing unit for generating a synthesized image by arranging and synthesizing, according to the relative positions, the pixels in the plurality of images captured by the imaging element.

2. The surface inspection device according to claim 1, wherein the setting unit comprises a relative movement unit for moving the imaging element and image relative to each other on the imaging surface,
wherein the surface inspection device further comprises a control unit for controlling the operation of the relative movement unit and the imaging element so that the imaging element captures a plurality of images at a plurality of relative positions while the relative movement unit performs relative movement by an amount of relative movement smaller than the spacing between the pixels, and
wherein the image processing unit arranges and synthesizes, in an order according to the relative movement, the pixels in the plurality of images captured by the imaging element; and
generates a synthesized image.

3. The surface inspection device according to claim 2, wherein the relative movement unit performs the relative movement so that the light-receiving portion is positioned in the position of the dead portion prior to the relative movement.

4. The surface inspection device according to claim 2,
wherein the relative movement unit has a stage drive unit for moving the stage in two perpendicular directions, and
wherein the control unit controls the operation of the stage drive unit to obtain an amount of movement for the stage calculated from the relative movement amount in accordance with an imaging magnification of the light-receiving optical system.

5. The surface inspection device according to claim 2, further comprising:
a measurement unit for measuring the actual relative movement condition based on the plurality of images captured by the imaging element, and
a correction unit for correcting the amount of control performed by the control unit on the relative movement unit so that there is no discrepancy between the actual relative movement condition measured by the measurement unit and a target relative movement condition.

6. The surface inspection device according to claim 5, wherein the measurement unit measures the relative movement condition at a precision smaller than the spacing between pixels by performing image processing on a plurality of images.

7. The surface inspection device according to claim 5, wherein the measurement unit sets a plurality of reference areas in an image, and measures the actual relative movement condition by determining positions of a plurality of reference areas in a plurality of images.

8. The surface inspection device according to claim 1, comprising a plurality of imaging elements,
wherein the light-receiving optical system is configured to capture individual images on the imaging surfaces of the plurality of imaging elements,
wherein the plurality of imaging elements are arranged in a plurality of corresponding relative positions so that the dead portions can be compensated for by the setting unit during imaging, and the individual images can be captured in the corresponding relative positions; and
wherein the image processing unit generates a synthesized image from a plurality of images taken by the plurality of imaging elements.

9. The surface inspection device according to claim 8, wherein a light-receiving portion in one of the plurality of imaging elements receives and detects light from an image that has reached the dead portion in another imaging element.

10. The surface inspection device according to claim 8, wherein the light-receiving optical system has a splitting unit for splitting, into a plurality of beams, light from the surface of the substrate illuminated by ultraviolet light, and an imaging unit for directing the plurality of light beams to the imaging surfaces of a plurality of imaging elements and capturing a plurality of images.

11. The surface inspection device according to any claim 8, wherein the plurality of imaging elements constitutes four imaging elements.

12. The surface inspection device according to claim 1, further comprising an inspection unit for inspecting the surface of the substrate based on the synthesized image generated by the image processing unit.

13. The surface inspection device according to claim 3,
wherein the relative movement unit has a stage drive unit for moving the stage in two perpendicular directions, and
wherein the control unit controls the operation of the stage drive unit to obtain an amount of movement for the stage calculated from the relative movement amount in accordance with an imaging magnification of the light-receiving optical system.

14. The surface inspection device according to claim 3, further comprising:
a measurement unit for measuring the actual relative movement condition based on the plurality of images captured by the imaging element, and a correction unit for correcting the amount of control performed by the control unit on the relative movement unit so that there is no discrepancy between the actual relative movement condition measured by the measurement unit and a target relative movement condition.

15. The surface inspection device according to claim 4, further comprising:
a measurement unit for measuring the actual relative movement condition based on the plurality of images captured by the imaging element, and
a correction unit for correcting the amount of control performed by the control unit on the relative movement unit so that there is no discrepancy between the actual relative movement condition measured by the measurement unit and a target relative movement condition.

16. The surface inspection device according to claim 6, wherein the measurement unit sets a plurality of reference areas in an image, and measures the actual relative movement condition by determining positions of a plurality of reference areas in a plurality of images.

17. The surface inspection device according to claim 9, wherein the light-receiving optical system has a splitting unit for splitting, into a plurality of beams, light from the surface of the substrate illuminated by ultraviolet light, and an imaging unit for directing the plurality of light beams to the imaging surfaces of a plurality of imaging elements and capturing a plurality of images.

18. The surface inspection device according to claim 9, wherein the plurality of imaging elements constitutes four imaging elements.

19. The surface inspection device according to claim 10, wherein the plurality of imaging elements constitutes four imaging elements.

20. The surface inspection device according to claim 2, further comprising an inspection unit for inspecting the surface of the substrate based on the synthesized image generated by the image processing unit.

21. The surface inspection device according to claim 3, further comprising an inspection unit for inspecting the surface of the substrate based on the synthesized image generated by the image processing unit.

22. The surface inspection device according to claim 4, further comprising an inspection unit for inspecting the surface of the substrate based on the synthesized image generated by the image processing unit.

23. The surface inspection device according to claim 5, further comprising an inspection unit for inspecting the surface of the substrate based on the synthesized image generated by the image processing unit.

24. The surface inspection device according to claim 6, further comprising an inspection unit for inspecting the surface of the substrate based on the synthesized image generated by the image processing unit.

25. The surface inspection device according to claim 7, further comprising an inspection unit for inspecting the surface of the substrate based on the synthesized image generated by the image processing unit.

26. The surface inspection device according to claim 8, further comprising an inspection unit for inspecting the surface of the substrate based on the synthesized image generated by the image processing unit.

27. The surface inspection device according to claim 9, further comprising an inspection unit for inspecting the surface of the substrate based on the synthesized image generated by the image processing unit.

28. The surface inspection device according to claim 10, further comprising an inspection unit for inspecting the surface of the substrate based on the synthesized image generated by the image processing unit.

29. The surface inspection device according to claim 11, further comprising an inspection unit for inspecting the surface of the substrate based on the synthesized image generated by the image processing unit.
